(19) United States
(12) Patent Application Publication
(10) Pub. No.: US 2022/0347944 A1
(43) Pub. Date: Nov. 3, 2022

(54) W-AXIS FIBER PLACEMENT HEAD

(71) Applicant: Fives Machining Systems, Inc., Fond du Lac, WI (US)

(72) Inventors: Erik Lund, Mercer Island, WA (US); Brent Lee Keller, Cincinnati, OH (US); Matthew Brian Chalk, Villa Hills, KY (US); Martha Anne Bauer, Cincinnati, OH (US)

(21) Appl. No.: 17/063,105

(22) PCT Filed: Oct. 1, 2020
(86) PCT No.: PCT/US2020/053688

§ 371 Date: Oct. 5, 2020

Related U.S. Application Data
(60) Provisional application No. 62/911,558, filed on Oct. 7, 2019.

(51) Int. Cl. B29C 70/38

(52) U.S. Cl. CPC B29C 70/384; B29C 70/388

(57) ABSTRACT

A fiber placement head for applying a plurality of composite tape segments on a mold including a frame that supplies composite tape for application to the mold is configured to be releasably connected to a robotic arm; a tape application assembly that is slidably carried by the frame and applies the composite tape segments to the mold, wherein the tape application assembly moves linearly from one end of the frame toward another end of the frame along a W-axis

### CROSS-REFERENCE TO RELATED PATENT APPLICATION

This application claims the benefit of priority from U.S. Provisional patent application Ser. No. 62/911,558 filed on Oct. 7, 2019, the entire contents of which are hereby incorporated by reference.

### TECHNICAL FIELD

The present application relates to fiber placement machines and, more particularly, to a fiber placement head that is capable of motion along a W-axis and used with a fiber placement machine.

### BACKGROUND

Fiber placement machines are used to create composite workpieces. Composite material, in the form of fibrous material impregnated with resin, is applied by the machines to a mold or mandrel at precise locations and lengths to collectively form a composite workpiece. The fiber placement machine moves a fiber placement head relative to the mold to precisely apply composite tape in the ultimate shape of the composite workpiece. As the fiber placement head moves, it leaves a plurality of composite tape segments, also referred to as a course, or tows, behind on the mold. The automatic application of these composite tape segments to the mold involves the cooperation of a diverse collection of machinery that holds, moves, and ultimately cuts the composite tape.

Fiber placement machines can include a mechanism that moves a fiber placement head relative to a plurality of axes to place the head in a precise position for applying the composite tape to the mold. And as the fiber placement machine lays the composite tape on the mold, the mechanism moves the entire head along a path across the mold. The fiber placement head can include a number of items that have significant mass, such as spools of composite tape that supply the material used for the composite tape segments. The mechanism moving the fiber placement head precisely along the path where the composite tape segment will be applied to the mold can consume significant amounts of energy. Overcoming resting inertia or precisely stopping the motion of the fiber placement head having significant mass may stress the mechanism moving the head. This stress may be increased when laying significant quantity of short composite tape segments.

### SUMMARY

In one implementation, a fiber placement head for applying a plurality of composite tape segments on a mold includes a frame that supplies composite tape for application to the mold is configured to be releasably connected to a robotic arm; a tape application assembly that is slidably carried by the frame and applies the composite tape segments to the mold, wherein the tape application assembly moves linearly from one end of the frame toward another end of the frame along a W-axis.

In another implementation, a fiber placement head for applying a plurality of composite tape segments on a mold includes a frame supplying composite tape for application to the mold; a tape application assembly is slidably carried by the frame along frame rails and applies the composite tape segments to the mold, wherein the fiber placement head moves along a linear path and the tape application assembly moves along a W-axis that is non-parallel to the linear path to apply composite tape segments to the mold.

### BRIEF DESCRIPTION OF THE DRAWINGS

FIG. 1 is a perspective view depicting an implementation of a fiber placement machine;

FIG. 2 is another perspective view depicting an implementation of a fiber placement head;

FIG. 3 is a perspective view depicting an implementation of a portion of a fiber placement head;

FIG. 4 is another perspective view depicting an implementation of a portion of a fiber placement head;

FIG. 5 is another perspective view depicting an implementation of a fiber placement head;

FIG. 6a is a plan view depicting an implementation of a robotic arm moving a fiber placement head; and

FIG. 6b is a plan view depicting another implementation of a robotic arm moving a fiber placement head.

### DETAILED DESCRIPTION

A fiber placement machine can use a robotic arm or gantry carrying a fiber placement head having an application roller or slide that moves along a W-axis relative to the fiber placement head. A cut, clamp, and restart (CCR) assembly that includes the application roller/slide can be moved relative to a frame of the fiber placement head, which may be held stationary by the robotic arm/gantry while composite tape is applied to the mold. The fiber placement head can include the frame that is detachably coupled with the robotic arm and moved into position relative to the mold. An application roller can then be linearly moved relative to the frame as composite tape segments are laid on the mold. The CCR assembly can pull composite tape from one or more composite tape spools carried by the frame as the CCR assembly linearly slides relative to the frame along the W-axis. The CCR assembly along with the application roller can be biased in one direction along the W-axis by a spring. In preparation of depositing composite tape segments on the mold, the CCR assembly can be moved to one end of an available range of motion against the spring force and held in that position. When the robotic arm is placed into a proximate position relative to the mold, the CCR assembly can be released and the spring can force the CCR assembly in a linear motion along the W-axis toward an opposite end of the available range of motion. The fiber placement head can allow the CCR assembly to reach the end of the available range of motion or the head can stop the CCR assembly along the W-axis. Multiple composite tape segments can be applied to the mold while moving the fiber placement head in only one linear axis. In contrast, past applications of composite tape segments have involved moving the fiber placement head along multiple axes.

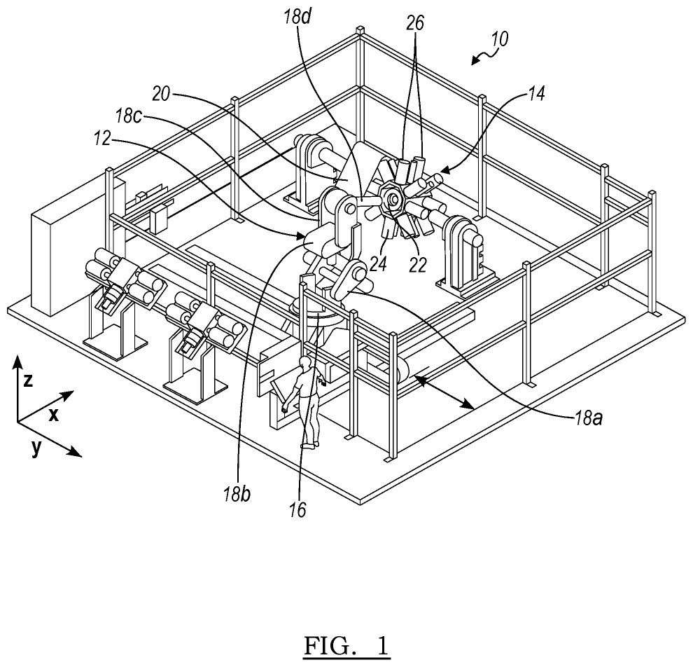

An implementation of a fiber placement machine 10 is shown in FIG. 1. The fiber placement machine 10 includes a robotic arm 12 that is detachably coupled with a fiber placement head 14. The robotic arm can be supported by a base 16 upon which it moves linearly about an axis (x). A plurality of moveable segments 18, that can move by pivoting, rotating, or telescoping for example, may extend outwardly from the base 16. The robotic arm 12 can move relative to the base 16 about multiple axes. For example, a first segment 18a can rotatably couple to the base 16 at one end such that the robotic arm 12 can rotate about the base 16. A second segment 18b can pivotably couple with the first segment 18a and a third segment 18c can pivotably couple with the second segment. A fourth segment 18d can be coupled to the third segment 18c and telescopically move away from and toward the third segment. The segments 18 can be moved relative to each other using fluidic rams, electric motors, or some combination of these or other drive elements to move a distal end of the robotic 12 arm relative to a mold 20 or mandrel used to create a workpiece.

A microprocessor (not shown) in communication with a computer readable storage medium having executable instructions can control movement of the fluidic rams, electric motors, or other drive element thereby controlling the motion and position of the moveable segments 18 of the robotic arm 12. The microprocessor can be any type of device capable of processing electronic instructions including microcontrollers, host processors, controllers, and application specific integrated circuits (ASICs). It can be a dedicated processor used only to carry out control of the robotic arm 12 or can be shared with other machine functions. The microprocessor executes various types of digitally-stored instructions, such as software or firmware programs stored in memory. Communications between the mechanism that moves the robotic arm, such as the fluidic rams or electric motors, and the microprocessor can be carried out over a communications bus.

The robotic arm 12 can move the fiber placement head 14 relative to four axes to position the head 14 for service or to apply composite tape to the mold 20. While this is one implementation of a robotic arm 12 that can be used with a fiber placement head, other implementation of robotic arms or mechanical devices that apply composite tape can be used as well. For example, the fiber placement head 14 can by used with a four-axis gantry that moves the head 14 in x, y, and z axes while also permitting the head 14 to rotate about the c-axis. Composite tape can refer to carbon fiber reinforced polymer (CFRP) that includes a hardening resin in an uncured state. This can be referred to as a “pre-preg” material and can contain carbon fibers as well as other materials. Heat can be applied to the composite tape to harden the material.

The end of the robotic arm 12 distal to the base 16 can include a chuck 22 that releasably engages the fiber placement head 14. The chuck 22 and a portion of the fiber placement head 14 can have corresponding features such that the chuck 22 can releasably grab the fiber placement head 14. In one implementation, the fiber placement head 14 includes a cylindrical shank extending orthogonal to a surface of the head 14. The robotic arm 12 can position the chuck 22 so that it engages the shank and the fiber placement head 14 is resiliently coupled to the arm 12.

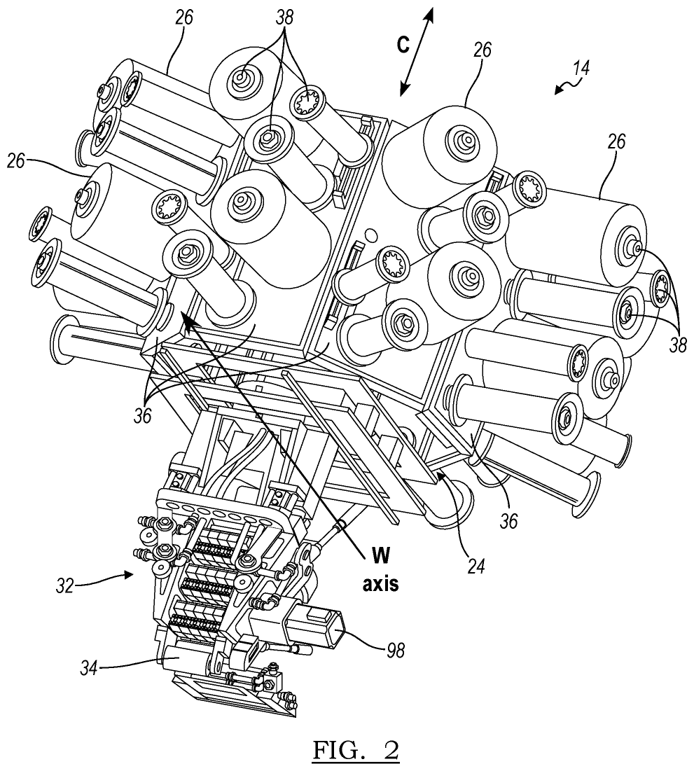

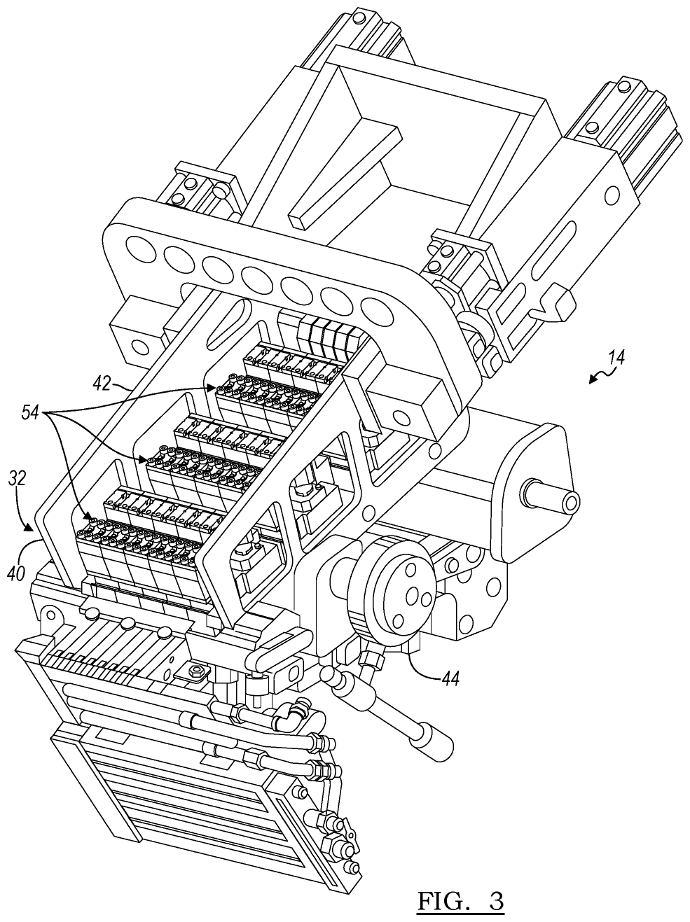

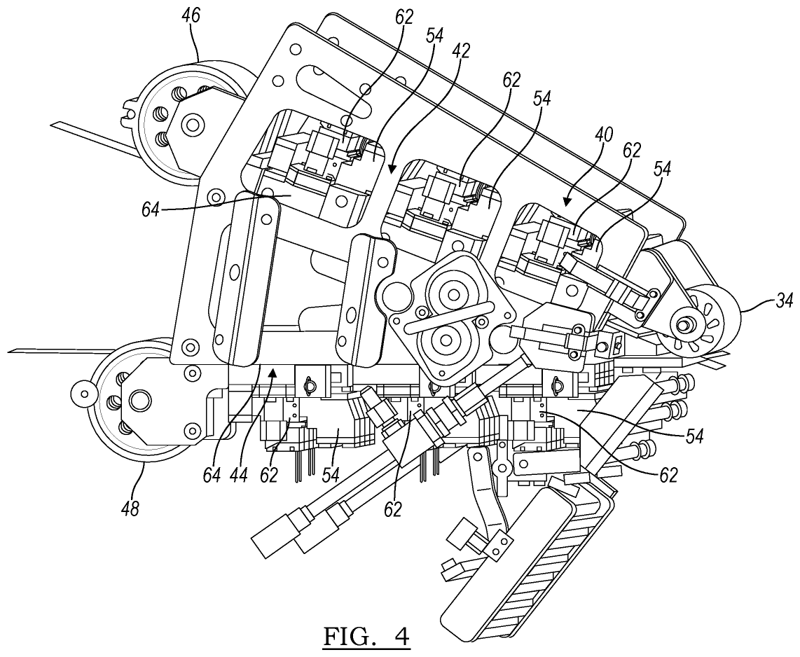

As shown in FIGS. 2-4, the fiber placement head 14 can include a frame 24, a plurality of spools 26 that carry composite tape as a source of this tape for the head 14, and a tape application assembly. In this implementation, the tape application assembly can be carried out by a cut, clamp, restart (CCR) assembly 32. The CCR assembly 32 can include a compaction roller 34 (or alternatively a compaction slide) that can receive the composite tape from the spools 26 and apply it to the mold 20 to create a composite part. The frame 24 includes a plurality of outer surfaces 36 and spindles 38 mounted orthogonally relative to the outer surfaces 36. The spindles 38 can be moved to create tape tension using dancer elements controlled pneumatically, mechanically, or fluidically that help maintain tension on the composite tape as the tape is applied to the mold 20. The composite tape can unwind from the spools 26 and travel into the compaction roller 34 for ultimate application to the mold 20. The CCR assembly 32 can slide relative to the frame 24 along the W-axis. This will be discussed in more detail below.

The fiber placement head 14 can include a CCR frame 40 for supporting the components of the fiber placement head 14, the CCR assembly 32, and the compaction roller 34 that ultimately presses the course of composite tapes onto the mold 20. Before arriving at the compaction roller 34, a portion of the composite tapes can pass through an upper feed portion 42 and another portion of the composite tapes can pass through a lower feed portion 44. The upper feed portion 42 can process even numbered composite tape and the lower feed portion 44 can process odd numbered composite tape that meet at the compaction roller 34. For instance, for a fiber placement head 14 having eight fiber pathways or lanes, the upper feed portion 42 can process composite tape identified by numbers 2, 4, 6, and 8 while the lower feed portion 44 can process composite tape identified by numbers 1, 3, 5, and 7. The upper feed portion 42 and the lower feed portion 44 can be separated by an angle (a). An upper feed roller 46 and lower feed roller 48 can communicate composite tape from spools 26 to the upper feed portion 42 and lower feed portion 44, respectively. A plurality of lane modules 54 can be included with the upper feed portion 42 and the lower feed portion 44.

Each of the upper feed portion 42 and the lower feed portion 44 can include a manifold 64 for receiving a plurality of mounting bases 52 that can releasably receive a plurality of the lane modules 54. Electromechanical valves 62 abut the lane modules 54 and can be coupled to a mounting base via a rear air block. Each lane module 54 can abut an electromagnetic valve 62 such that the valve 62 selectively supplies compressed air to the module 54 for actuation. The mounting base can couple with the manifold 64 and fluid passageways communicate compressed air from a source through the rear air block and the electromechanical valves 62 ultimately arriving at the lane modules 54 coupled to the mounting base 52. Compressed air can be selectively supplied to a lane module 54 by the electromagnetic valve 62 thereby communicating the air from the manifold 64 and the rear air block. In one implementation, the electromagnetic valve 62 includes a solenoid receiving a voltage that is controlled by a switch the microprocessor opens and closes to control actuation of the lane module 54.

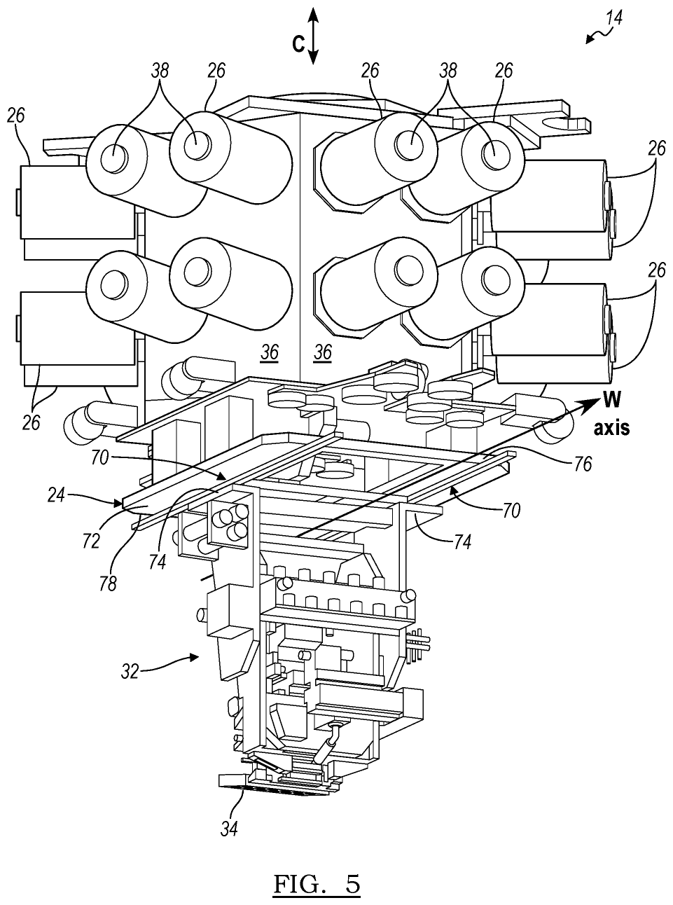

Turning to FIG. 5, the fiber placement head 14 is shown having the frame 24 and the CCR assembly 32 that slides linearly along the W-axis relative to the frame 24. The frame 24 can include frame rails 70 on a frame surface 72 that is opposite to the chuck 22, which releasably engages the fiber placement head 14. The frame surface 72 can face the mold 20 onto which the fiber placement head 14 applies composite tape segments. The CCR assembly 32 can include CCR rails 74 that correspond to and engage the frame rails 70. The frame rails 70 and the CCR rails 74 can have L-shaped cross-sections such that the CCR rails 74 engage the frame rails 70 and support the CCR assembly 32 from the frame 24. Apart from support, the rails 70, 74 permit movement of the CCR assembly 32 relative to the frame 24 along the W-axis. The W-axis can be angularly displaced relative to the x, y, and z axes as the fiber placement head 14 rotates relative to the robotic arm 12 about the c-axis. The CCR assembly 32 and compaction roller 34 can be angularly displaced relative to the x-axis, y-axis, or z-axis by roughly 90 degrees so composite tape can be applied to the mold 20 at different angles as the CCR assembly 32 moves along the W-axis.

A spring (not shown) can bias the CCR assembly 32 toward a first end 76 of the frame 24. Before applying a segment of composite tape on the mold 20, the CCR assembly 32 can be moved toward a second end 78 of the frame 24 overcoming the spring force of the spring. As part of moving the CCR assembly 32 from the first end 76 to the second end 78, composite tape can be drawn from the spools 26 preparing the CCR assembly 32 to apply one or more segments of composite tape. The CCR assembly 32 can be held in position at the second end 78. The robotic arm 12 can move the CCR assembly 32 along the mold 20 so that the compaction roller 34 is positioned at one edge of the mold 20. The CCR assembly 32 can be released and the spring can move the CCR assembly 32 along the W-axis. As the CCR assembly 32 moves relative to the frame 24, the compaction roller 34 can apply composite tape to the mold 20. After the CCR assembly 32 reaches the first end 76, the robotic arm 12 can move the CCR assembly 32 relative to the mold 20 along the y-axis. The CCR assembly 32 can be allowed to travel to the first end 76 or can be stopped at some point along the W-axis in between the first end 76 and the second end 78. The process can then be repeated for additional applications of composite tape on the mold 20.

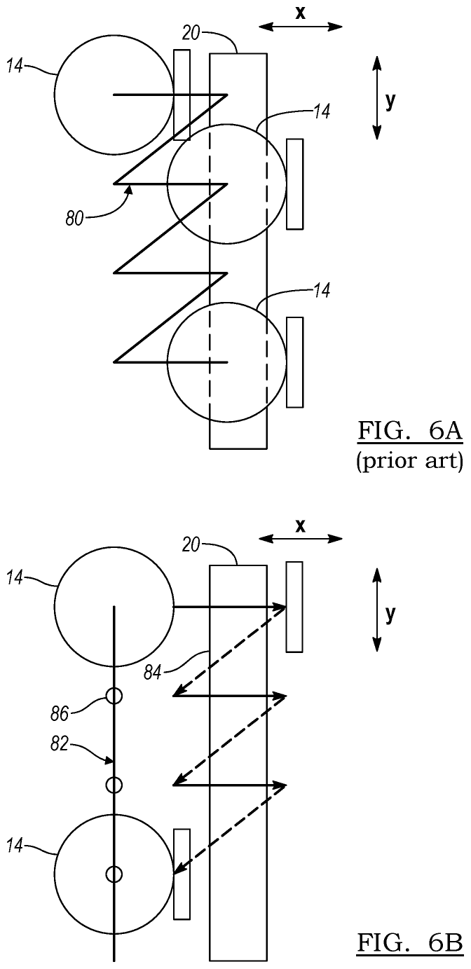

Turning to FIGS. 6a-6b, different plan views are shown of fiber placement head movement relative to a mold or mandrel onto which composite tape sections are applied. With respect to FIG. 6a, the fiber placement head 14 is shown moving along a zigzag path 80 as the robotic arm 12 applies composite tape to the mold 20 without moving the CCR assembly 32 along the W-axis. Without moving the CCR assembly 32 along the W-axis, the robotic arm 12 moves the fiber placement head 14 relative to both the x- and y-axes. In this implementation, the robotic arm 12 moves the fiber placement head 14 along the entire path where the composite tape is applied to the mold 20. In contrast, FIG. 6b depicts the fiber placement head 14 moving along a linear path 82. In this implementation, only the CCR assembly 32 moves along the path where composite tape is applied to the mold 20 while the fiber placement head 14 remains stationary. The robotic arm 12 can position the fiber placement head 14 near an edge 84 of the mold 20. The CCR assembly 32 can be released and the spring may move the CCR assembly 32 along the W-axis and across the mold 20 a desired amount of travel to apply a desired amount of composite tape on the mold 20. The CCR assembly 32 may reach the first end 76 or the CCR assembly 32 may be stopped before reaching the first end 76. Once the CCR assembly 32 is stopped, the robotic arm 12 can move the fiber placement head 14 along the linear path 82 to a next position 86 along the edge 84 and an additional segment of composite tape can be applied to the mold 20. This process can be repeated depending on the number of composite tape segments that will be applied to the mold 20.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A fiber placement head for applying a plurality of composite tape segments on a mold, comprising:
a frame that supplies composite tape for application to the mold is configured to be releasably connected to a robotic arm;
a tape application assembly that is slidably carried by the frame and applies the composite tape segments to the mold, wherein the tape application assembly moves linearly from one end of the frame toward another end of the frame along a W-axis.

2. The fiber placement head recited in claim 1, wherein the tape application assembly further comprises a cut, clamp, and restart assembly.

3. The fiber placement head recited in claim 1, further comprising a shank that is configured to engage a chuck on a distal end of the robotic arm.

4. The fiber placement head recited in claim 1, further comprising a spring that biases the tape application assembly toward an end of the frame.

5. The fiber placement head recited in claim 1, wherein the tape application assembly moves linearly from the one end of the frame toward another end of the frame along the W-axis while the fiber placement head remains stationary.

6. The fiber placement head recited in claim 1, wherein the robotic arm rotates the frame about a C-axis.

7. A fiber placement head for applying a plurality of composite tape segments on a mold, comprising:
a frame supplying composite tape for application to the mold;
a tape application assembly is slidably carried by the frame along frame rails and applies the composite tape segments to the mold, wherein the fiber placement head moves along a linear path and the tape application assembly moves along a W-axis that is non-parallel to the linear path to apply composite tape segments to the mold.

8. The fiber placement head recited in claim 7, wherein the tape application assembly further comprises a cut, clamp, and restart assembly.

9. The fiber placement head recited in claim 7, further comprising a robotic arm that releasably couples to the fiber placement head to move the fiber placement head relative to the mold.

10. The fiber placement head recited in claim 9, wherein the robotic arm rotates the frame about a C-axis.

11. The fiber placement head recited in claim 7, further comprising a spring that biases the tape application assembly toward an end of the frame.

12. The fiber placement head recited in claim 7, wherein the tape application assembly moves linearly from the one end of the frame toward another end of the frame along the W-axis while the fiber placement head remains stationary.
